(19) United States
(12) Patent Application Publication
(10) Pub. No.: US 2012/0139723 A1
(43) Pub. Date: Jun. 7, 2012

(54) GPS Based Tracking And Reporting System

(76) Inventor: Carl Anthony (Tony) Avila, Phoenix, AZ (US)

(21) Appl. No.: 12/960,525

(22) Filed: Dec. 5, 2010

(51) Int. Cl. G08B 1/08

(52) U.S. Cl. 340/539.13

(57) ABSTRACT

A GPS based controlled tracking and monitoring system. A geo-fab transceiver device is connected with a GPS device. The user keeps a detached geo-fab transmitter. When the transceiver does not receive signals from the detached radio frequency transmitter, it sends an activation signal to the GPS to create a radius of the location for determining an “away” status. When a GPS attached object moves outside the boundary of the radius, alarm messages are sent to the user, and positioning information are constantly sent to a central server for the user's accessing through the internet. The user can send an automated email to a police from his/her online account.

### DESCRIPTION OF RELATED ART

The present application relates to a global position system (GPS), and more particularly to a GPS system that integrates an activation mechanism, communicates with a central server and provides real time tracking information about a moving object through the internet.

Note that the points discussed below may reflect the hindsight gained from the disclosed inventions, and are not necessarily admitted to be prior art.

Global Positioning System (GPS) devices, including graphical mapping software programs have been used for various applications, such as a personal navigation, resource planning, routing, fleet tracking, safety dispatching, etc. By measuring the time difference of GPS signals to and from two or three orbiting satellites, GPS receivers calculate the user's exact location, and display the geo-information on an electronic map. Using real-time communication networks GPS devices that are connected to a wireless modem are able to transfer their position coordinates, such as latitude and longitude, wirelessly to a computer or server for later retrieval or real time viewing of the geo-information remotely.

These remote communication applications may include Automatic Vehicle Location (AVL), Location-Based Services (LBS), Fleet Tracking Systems etc. technologies. For example, an AVL system, typically involves a positioning device connected to a wireless MODEM sending location information, amongst other telemetry information, at discrete time intervals to a computer for the viewing.

Monitoring and tracking is useful in locating a stolen vehicle or other precious objects. However, since current GPS system provides real time data display, constant monitoring is labor intensive, expensive and infeasible. US 2010/0274479 A1 describes an effort in storing the location historic information in database, and displaying a specific time period of location at the request of the user. Spatial and non-spatial related Meta data, reference or link spatial and non-spatial related Meta data are stored, retrieved, and graphically displayed for in a temporal or indexed format, such as a Calendar or Gantt view. But constantly receiving and storing location information may be expensive to maintain and largely unnecessary waste of computing capacity.

Although US Patent Application US 2010/0265140 A1 describes an apparatus for determining the current position of a subscriber in a portable terminal. The apparatus includes a controller for calculating the current position by receiving position information from neighbor terminals in the process of determining the current position. However, the disclosed apparatus has not been used for controlled tracking of a lost item, especially in monitoring and tacking a stolen vehicle.

### SUMMARY

The present application discloses a controlled and automated real time monitoring and tracking of a lost item.

In one aspect of an embodiment, a movable object for tracking is attached with a GPS electronically connected with a transceiver. A GeoFob controlling apparatus is provided to constantly communicate with the transceiver.

In another aspect of an embodiment, when the transceiver detects that the GeoFob is no longer in the proximity of the transceiver, it activates the GPS to record the present location and creates a radius of area for condition of being away. The location information is sent to a central server for internet access.

In another aspect of an embodiment, when the moving object moves beyond the radius area, an alarm message is automatically sent to the subscriber reporting the moving away of the object. The GPS sends to the central server the real time location information for mapping. The subscriber can login to his/her account to monitor and track the moving object on a map in real time.

In another aspect of an embodiment, the subscriber can automatically send emails to a police station reporting the moving away of the monitored object. In case of a vehicle be stolen, two emails may be sent, one to the subscriber's local police, one to the police station nearest to the vehicle. The emails may automatically include a description of vehicle and information of the ownership.

The disclosed innovation provides an easy and inexpensive way for automated monitoring and tracking of precious items. Centralized mapping enables a subscriber monitor and track a monitored object anywhere in the world via the internet.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 schematically shows an example GPS based geo-fence system for monitoring and tracking a lost item in accordance with this application.

FIG. 2 schematically shows an example of worldwide access of location information for a monitored item in accordance with this application.

FIG. 3 and FIG. 4 show a flowchart of an example automated alarming and reporting functions of geo-fence system in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present application described hereinafter relates to an apparatus and method for providing a geo-defense of alarming and reporting system using controlled monitoring of position information based on Global Positioning System (GPS) function.

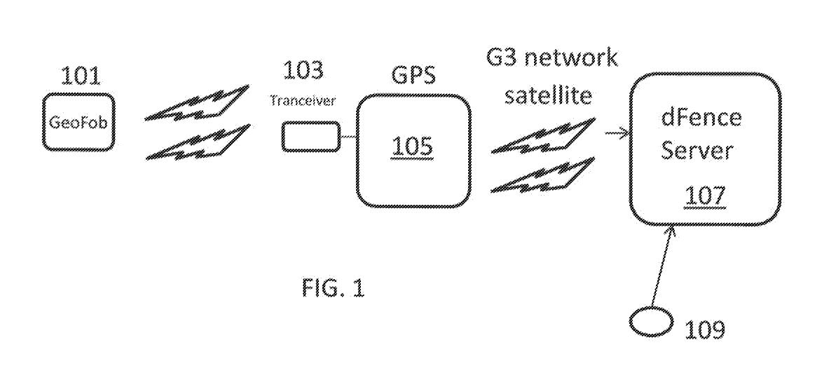

In reference to FIG. 1, an example geo-defense embodiment includes a GPS apparatus 105 that has an electronically connected transceiver 103 for constant communicating with a detached Geo-Fob 101. GeoFob 101 is generally closely kept and held by the user. GPS 105 is configured to wirelessly communicate with central server 107 enabled with mapping software and alarming and reporting messaging functions. A user 109 therefore can access server 107 anywhere in the world via the internet for location information provided by GPS 105.

The communication between GeoFob 101 and transceiver 103 is through transmitting and receiving a Radio Frequency (RF) signal that is input and output through an antenna (not shown). For example, in a transmitting process, data to be transmitted may be subject to a channel-coding process and a spreading process, and then the data is transformed to an RF signal. In a receiving process, the RF signal is received and transformed to a base-band signal, and the base-band signal is subject to a de-spreading process and a channel-decoding process, thereby restoring the data. The protocol for transmission of signals may be in one of the well-known CDMA and GSM or other similar protocols known in the art. In a preferred embodiment, the transceiver 103 will sense when the Geofob 101 is within 3 feet or outside of 3 feet of the transceiver 103. Alternatively, Bluetooth technology may be used for communication between Geofob 101 and transceiver 103.

In a preferred embodiment, transceiver 103 connects to GPS 105 via an input output wire, or alternatively GPS 105 has a built-in transceiver 103 function that communicates with a specific geofob in its proximity. GPS device 105 is configured to receive constant negative pulse when GeoFob device 101 is within 3 feet of the transceiver 103.

GPS device 105 is configured with a wireless MODEM and then reports via the G3 network into dFence Server 107 with location and verification that Proximity of Geofob 101 is working. Alternatively GPS device 105 reports to server 107 satellite network system. On server 107, a mapping software maps and displays the position information received from GPS 105. User 109, by logging into his/her account, activates server 107 to receive and display position information from GPS 105. Without user 109's logging in, the received position information is limited to be stored within a size and may be discarded within a specified time frame for reducing maintenance cost. The position information may be permanently stored until a specified time by the user.

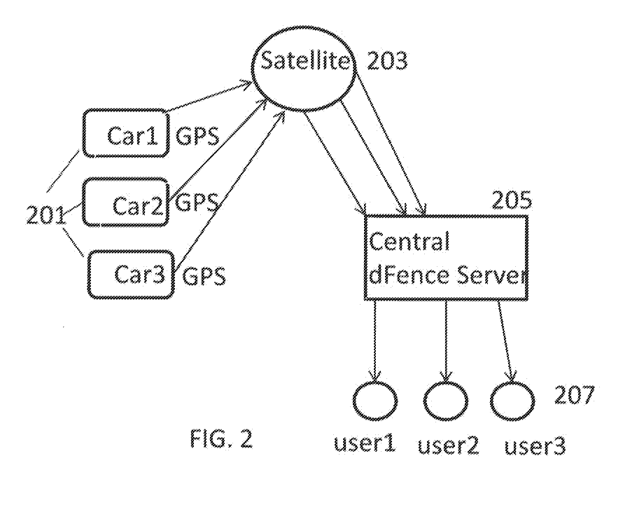

In reference to FIG. 2, it shows multiple users 107 may monitor and access the location information of their individual concerned motor vehicles 201 on the central dFence server 205 through the internet with their specific GPS settings and Geofobs. Location information may be sent via a satellite system 203 or the wireless data network, such as the G3 network.

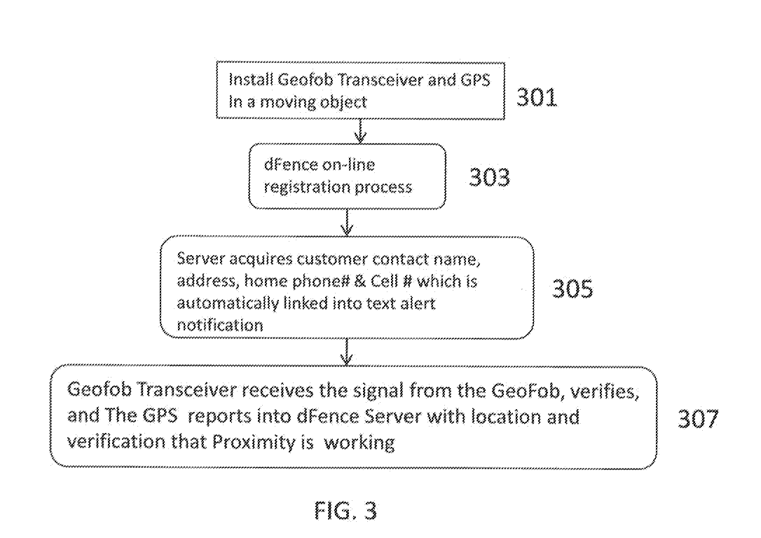

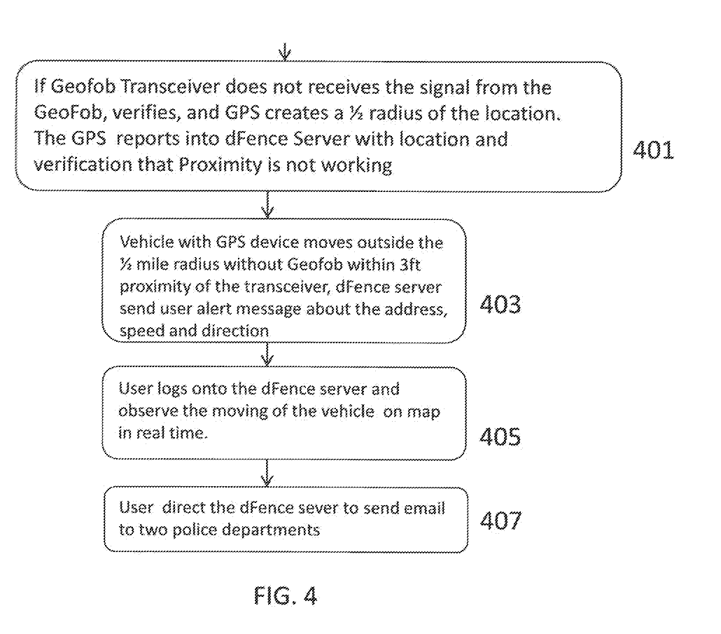

In reference to FIG. 3 and FIG. 4, the function steps of a preferred embodiment of a geo-defense system are described. After installing a Geofob Transceiver and GPS in the object, for example, a vehicle, for monitoring at step 301, the user keeps a geo-fob with him/her personally, goes to the geo-defense web site to register a description of the object to be monitored and the user's contact information at step 303.

The geo-defense Server acquires and stores the customer contact name, address, home phone number & cell number which is automatically linked into text alert notification at step 305. An account is established and GPS is activated to send location information to the geo-defense server.

A testing may be performed that Transceiver receives the signal from the GeoFob, preferably within the proximity of 3 feet, verifies, for example 5 times, then send negative impulse to the GPS. The GPS reports into dFence Server with location and verification that Proximity is working at step 307. GPS device is configured to receive constant negative pulse when GeoFob device is within 3 feet of the Transceiver.

When GeoFob leaves proximity (3 ft) of the transceiver, the transceiver verifies 5 times that the device has left the parameter of greater than 3 ft and delays sending away pulse for 30 seconds. After away is verified the Transceiver sends a positive pulse to the GPS device. GPS device then creates a Geofence of ½ mile radius around the location of the GPS device. The GPS reports into dFence Server with location and verification that Proximity is not working at step 401.

When the object or the vehicle with GPS device moves outside the ½ mile radius without Geofob within 3 ft proximity of the transceiver, GPS constantly reports its location information to the dFence server which in term send user alert message about the address, speed and direction of the object or the vehicle at step 403. For example the user receives a cell text alert #1 stating a “GEOFOB” alert and the description of the vehicle. “If your vehicle is stolen report the following messages to 911 as a crime in progress.” Cell text alerts #2 through #15 may be further sent. The user receives Address, Speed and Direction of the vehicle every 2 minutes.

The user may verify the status of the object or the vehicle, and log onto the dFence server to observe the moving of the vehicle on map in real time at step 405. At the his/her account, the user may direct the dFence sever to send automated emails to two police departments reporting the loss of the item or vehicle and description the item and contact information.

The above-described methods according to the present invention can be realized in hardware as software or computer code that can be stored in a recording medium such as a CD ROM, all RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following publications, all of which are hereby incorporated by reference herein for all purposes: US Patent Application No. US 2010/0274479 A1, and US Patent Application No. US 2010/0265140 A1.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A controlled tracking electronic device system, comprising:
a detached first transmitter device that constantly emits electronic impulses at a specific time interval;
a GPS device having attachable mechanism to a moving object;
a second transceiver device, electronically connected with said GPS, being configured to constantly receive electronic signals from said first device; and
a central server system enabled with a mapping software, communicating with said GPS wirelessly, receiving location information from said GPS upon request of a user.

2. The controlled tracking electronic device system of claim 1, further comprising a user terminal that communicates to said central server through the internet, and retrieves said location information and analyses said location information with a local mapping software.

3. The controlled tracking electronic device system of claim 1, wherein said GPS is activated to send location information by a registration process of the user.

4. The controlled tracking electronic device system of claim 1, wherein the central server system is configured to send auto-generated email messages to a police station.

5. The controlled tracking electronic device system of claim 1, wherein the central server system is configured to send alarm messages to the user when the GPS device moves outside of a boundary area from where the GPS is activated and without detecting said first transmitter device.

6. The controlled tracking electronic device system of claim 1, wherein said GPS sends alarm messages to the user when the GPS device moves outside of a boundary area from where the GPS is activated and without detecting said first transmitter device.

7. The controlled tracking electronic device system of claim 1, wherein said second receiver device sends a negative signal to said GPS when it detects said first device, and said GPS upon receiving negative signal reports to said server a location and a normal “proximity” status.

8. The controlled tracking electronic device system of claim 1, wherein said second receiver device sends a positive signal to said GPS when it detects no signal from said first device, and said GPS upon receiving positive signal creates a radius area for determining an “away” status.
